(19) United States
(12) Patent Application Publication
(10) Pub. No.: US 2017/0132912 A1
(43) Pub. Date: May 11, 2017

(54) INTELLIGENT REMOTE CONTROL, ELECTRONIC DEVICE CONTROL SYSTEM AND ELECTRONIC DEVICE CONTROL METHOD

(71) Applicant: INSTITUTE FOR INFORMATION INDUSTRY, Taipei City (TW)

(72) Inventors: TE-SAN LIAO, Taipei City (TW); HSIAO-HUNG LIN, Taipei City (TW); WEI-FAN CHEN, Taipei City (TW)

(21) Appl. No.: 14/953,550

(22) Filed: Nov. 30, 2015

(30) Foreign Application Priority Data
Nov. 6, 2015 (TW) 104136644

(51) Int. Cl. G08C 23/04

(52) U.S. Cl. CPC G08C 23/04

(57) ABSTRACT

Disclosed is an electric device control system comprising an electric device control system and an intelligent remote control. Each electric device is electrically connected to a light sensing device, wherein the electric device is controlled by the light sensing device. The intelligent remote control comprises a light transmitter, a first wireless communication unit and a first controller. The light transmitter provides a high energy level visible light beam to a light sensing device, to make the light sensing device provide a wireless identification signal. The first wireless communication unit receives the wireless identification signal. The first controller is electrically connected to the first wireless communication unit. The first controller controls a coding set to switch according to the wireless identification signal, and controls the first wireless communication unit according to the coding set to output a wireless control signal to the light sensing device for controlling the electric device.

### BACKGROUND

1. Field

The instant disclosure relates to an intelligent remote control, in particular, to an intelligent remote control, an electronic device control system using the same and an electronic device control method thereof.

2. Description of Related Art

With the technology well developed, there are more and more indoor electronic devices can be controlled remotely. For example, an intelligent environment can comprise the video and audio device, the light, the air conditioner (cooling/heating), the computer, the printer, the refrigerator, the micro wave oven, the washing machine, the garage door, the door locker, the dehumidifier and other electronic devices. Theses electronic devices may have it corresponding remote control. Therefore, for a user in an intelligent environment, he may have lots of remote controls in hand. The remote controls are so many that the user may not be able to conveniently use these remote controls to control the corresponding electronic devices. Also, these remote controls may occupy some indoor spaces.

Currently, there is a universal remote control on the market. The universal remote control comprises a plurality of buttons and a plurality of code sets of kinds of electronic devices. Thus, the user can use the universal remote control to control a plurality of electronic device with few universal remote controls.

However, there are still some problems when using the universal remote controls. First, the user needs to manually select the electronic device to be controlled, which may decrease the convenience as controlling the electronic device. Second, the volume of the universal is usually small so that it would be not easy for the user to press the right button to control the corresponding electronic device. Third, the amount of the electronic devices that can be controlled by the universal remote control is limited. The user cannot use one universal remote control to control each electronic device when the electronic devices are too many. Finally, the universal remote control transmits the control signal to the corresponding electronic device via the IR. However, the IR signal decays easily so that the controlling range of the universal remote control is restricted.

### SUMMARY

The instant disclosure provides an intelligent remote control. The intelligent remote control comprises a light transmitter, a first wireless communication unit and a first controller. The light transmitter provides a high energy level visible light beam to a light sensing device, so as to make the light sensing device provide a wireless identification signal. The first wireless communication unit receives the wireless identification signal. The first controller is electrically connected to the first wireless communication unit. The first controller controls a coding set to switch according to the wireless identification signal, and controls the first wireless communication unit according to the coding set to output a wireless control signal to the light sensing device for controlling an electric device.

The instant disclosure further provides an electric device control system. The electric device control system comprises electric device control system and an intelligent remote control. Each electric device is electrically connected to a light sensing device, wherein the electric device is controlled by the light sensing device. The intelligent remote control comprises a light transmitter, a first wireless communication unit and a first controller. The light transmitter provides a high energy level visible light beam to a light sensing device, so as to make the light sensing device provide a wireless identification signal. The first wireless communication unit receives the wireless identification signal. The first controller is electrically connected to the first wireless communication unit. The first controller controls a coding set to switch according to the wireless identification signal, and controls the first wireless communication unit according to the coding set to output a wireless control signal to the light sensing device for controlling the electric device.

The instant disclosure further provides an electronic device control method. The electronic device control method is used in an electronic device control system. The electronic device control system comprises at least an electric device and an intelligent remote control, wherein each electric device is electrically connected to a light sensing device. The electronic device control method comprising: (A) the intelligent remote control provides a high energy level visible light beam to the light sensing device; (B) after being triggered, the light sensing device provides a wireless identification signal to the intelligent remote control; (C) the intelligent remote control switches a coding set according to the wireless identification signal; and (D) the intelligent remote control controls its first wireless communication unit according to the coding set to output a wireless control signal to the light sensing device for controlling the electric device.

To sum up, the intelligent remote control, in the electric device control system and method provided by the instant disclosure, the electric device can be correspondingly controlled by directly providing a high energy level visible light beam to the light sensing device. Thereby, the user can control the position which the high energy level visible light beam lights onto, to make the high energy level visible light beam onto the light sensing device that the electronic device tends to control, so as to overcome the difficult operation of the interface of the traditional universal remote control. In other words, the universal remote control can make the user choose to control an electronic device directly and intuitively.

For further understanding of the instant disclosure, reference is made to the following detailed description illustrating the embodiments and embodiments of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a schematic diagram of an electric device control system of one embodiment of the instant disclosure.

FIG. 2 shows a flow chart of an electric device control method of one embodiment of the instant disclosure.

FIG. 3 shows a schematic diagram of an electric device control system of another embodiment of the instant disclosure.

### DETAILED DESCRIPTION

The aforementioned illustrations and following detailed descriptions are exemplary for the purpose of further explaining the scope of the instant disclosure. Other objectives and advantages related to the instant disclosure will be illustrated in the subsequent descriptions and appended drawings.

It will be understood that, although the terms first, second, third, and the like, may be used herein to describe various elements, these elements should not be limited by these terms. These terms are only to distinguish one element from another element, and the first element discussed below could be termed a second element without departing from the teachings of the instant disclosure. As used herein, the term “and/or” includes any and all combinations of one or more of the associated listed items.

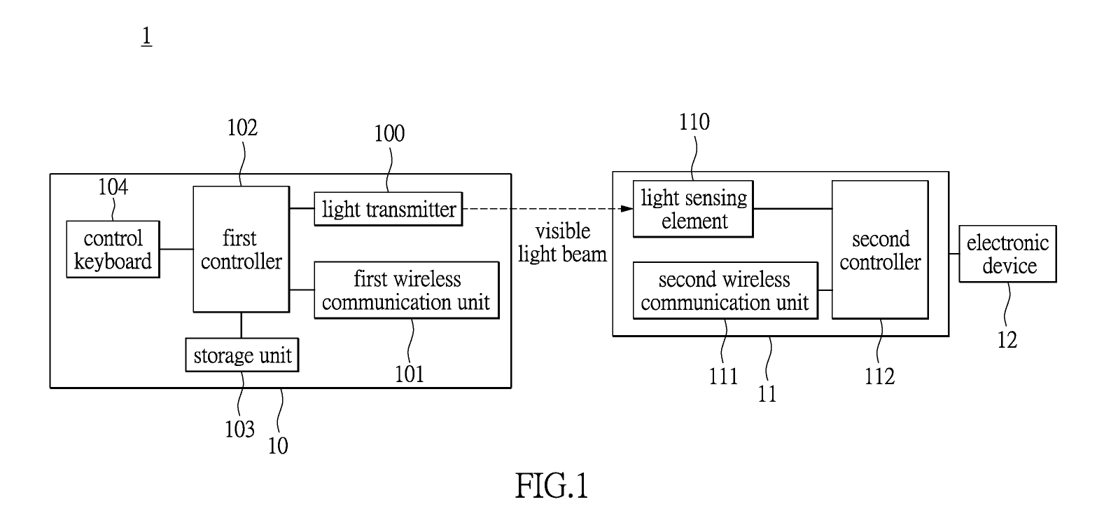

Please refer to FIG. 1. FIG. 1 shows a schematic diagram of an electric device control system of one embodiment of the instant disclosure. The electric device control system 1 comprises an intelligent remote control 10, at least one light sensing device 11 and at least one electronic device 12. Each electronic device 12 is electrically connected to a light sensing device 11, and there is a connection built between each electronic device 12 and its corresponding light sensing device 11. In this embodiment, the light sensing device 11 is an independent device that is electrically connected to the electronic device 12. For the convenience of illustration, the electric device control system 1 shown in FIG. 1 only has one light sensing device 11 and one electronic device 12. In other embodiments, electric device control system 1 can also comprise a plurality of light sensing devices 11 and a plurality of electronic devices 12.

The following description is going to illustrate the inner structure of the intelligent remote control 10 with light pointer guiding. The intelligent remote control 10 comprises a light transmitter 100, a first wireless communication unit 101, a first controller 102, a storage unit 103 and a control keyboard 104. The light transmitter 100, the first wireless communication unit 101, the storage unit 103 and the control keyboard 104 are respectively connected to the first controller 102. The intelligent remote control 10 is configured to provide the wireless control signal to control kinds of electronic devices 12. The electronic device 12 can be any of intelligent electric devices, such as television, video and audio device, the light, the air conditioner (cooling/heating), the computer, the printer, the refrigerator, the micro wave oven, the washing machine, the garage, the door locker, the dehumidifier and the like, and it is not limited herein.

The light transmitter 100 can be a laser diode or a light emitting diode (LED), to provide a high energy level visible light beam onto the light sensing device 11, such that the light sensing device 11 provides a wireless identification signal. The light transmitter 100 in this embodiment is a laser diode, so the high energy level visible light beam is a laser beam. The high energy level visible light beam is also used for light pointer guiding.

The first wireless communication unit 101 comprises proper logics, circuits and/or codes, and is configured to communicate wirelessly with the light sensing device 10, such as outputting the wireless control signal to the light sensing device 11. The first wireless communication unit 101 outputs the wireless control signal via the BlueTooth communication technology, the radio frequency identification communication technology, or Wi-Fi. In other embodiments, the first wireless communication unit 101 can output the wireless control signal via other wireless communication technologies, and it is not limited herein.

The control keyboard 104 comprises a plurality of control buttons (not shown in FIG. 1), and is provided to the user for a corresponding operation. For example, the control keyboard 104 comprises a power switch, a number choosing button, a volume control button, a program choosing button, a wind direction control button, a wind strength control button and the like. In short, the user can use the control keyboard 104 to control kinds of electronic devices 12. In some embodiments, the control keyboard 104 can be a digital keyboard displayed via a touch screen, which provides corresponding digital control buttons to the user for corresponding operations.

The first controller 102 comprises proper logics, circuits and/or codes, and is configured to generate a control signal according to the signals output by the control keyboard and the coding set used by the electronic device 12. The first controller 102 outputs the control signal to the first wireless communication unit 101, and controls the first wireless communication unit 101 to convert the control signal to the wireless control signal.

In addition, the first controller 102 is also configured to control the light transmitter 100. When the user tends to control the electronic device 12, the user can control the control button of the high energy level visible light beam of the control keyboard 104, such that the first controller 102 control the light transmitter 100 to start to output the high energy level visible light beam. Also, the user make the intelligent remote control 10 aim at the light sensing device 11, such that the high energy level visible light beam can light onto the light sensing element 110 of the light sensing device 11. The light sensing device 11 provides a wireless identification signal to the intelligent remote control 10 according to the high energy level visible light beam, to help a connection to be built between the intelligent remote control 10 and the electronic device 12.

The storage unit 103 comprises proper logics, circuits and/or codes. It is configured to store at least one coding set and record the wireless identification signal corresponding to each coding set for providing the wireless identification signal to the first controller 102. The first controller 102 correspondingly switches the coding set according to the received wireless identification signal. Each coding set is configured to record the wireless control signal corresponding to each control button of the intelligent remote control 10.

The following description is going to illustrate the structure of the light sensing device 11. The light sensing device 11 comprises a light sensing element 110, a second wireless communication unit 111 and a second controller 112. The light sensing element 110 and the second wireless communication unit 111 are electrically connected to the second controller 112 respectively. The light sensing device 11 helps a connection to be built between the intelligent remote control 10 and the electronic device 12, and controls the corresponding electronic device 12 according to the wireless control signal provided by the intelligent remote control 10.

The light sensing element 110 is configured to sense the high energy level visible light beam. The light sensing element 110 can be a photo diode, a photo crystal, a photo-gate, a pinned photo diode or a combination thereof, which is an electric element able to convert the high energy level visible light beam into electric charges. The light sensing element 110 can also be a complementary metal-oxide-semiconductor (CMOS) image sensor or the charge-coupled device (CCD) image sensor, to capture images according to the light intensity of the high energy level visible light beam.

In addition, in some embodiments, the area of the light sensing element 110 where the high energy level visible light beam lights is preferably greater than the area of the light sensing element 110 itself; however, it is not limited herein. Specifically speaking, if the area of the light sensing element 110 where the high energy level visible light beam lights is so small, and the user would need to make the light transmitter 100 aim at the light sensing element 110 very precisely to make the light sensing element 110 sense the high energy level visible light beam. On contrary, if the area of the light sensing element 110 where the high energy level visible light beam lights is greater than the area of the light sensing element 110, and as long as the user roughly makes the light transmitter 100 aim toward the light sensing element 110, the light sensing element 110 can sense the high energy level visible light beam. Thus, in this embodiment, by adjusting the light opening of the light transmitter, the scattering area of the high energy level visible light beam would be enlarged and the area of the light sensing element 110 where the high energy level visible light beam lights would be further enlarged.

The second controller is configured to control the second wireless communication unit 111 according to the high energy level visible light beam sensed by the light sensing element 110. In the following description, the photo diode is taken as an example of the light sensing element 110. When the light sensing element 110 senses the high energy level visible light beam, the light sensing element 110 converts the high energy level visible light beam into electric charges and generates a triggering signal according to the light intensity of the high energy level visible light beam. The second controller 112 receives the triggering signal, and determines whether the intensity of the high energy level visible light beam is larger than a threshold. If the intensity of the high energy level visible light beam is smaller than the threshold, and the second controller 112 determines that the light received by the light sensing element 110 may be the ambient light but not the high energy level visible light beam, wherein the ambient light is not the high energy level visible light beam, such as the light provided by the fluorescent lamp. In this case, the second controller 112 would not control the second wireless communication unit 111 to execute any operation. On contrary, if the intensity of the high energy level visible light beam is larger than the threshold, the second controller 112 outputs an identification signal, wherein the identification signal comprises a device code and a coding type. The device code represents for the identification code of the light sensing device 11, and the coding type represents for the coding set that the corresponding electronic device operates in.

In other embodiments, the second controller 112 also comprises a timer (not shown in FIG. 1). The timer is configured to calculate how long the high energy level visible light beam lights onto the light sensing element 110. When the light intensity of the high energy level visible light beam is larger than the threshold, and when the high energy level visible light beam lights onto the light sensing element 110 over a predetermine time duration, the second controller 112 would output an identification signal.

In addition, the skilled in the art can adjust the above mentioned threshold and the predetermined time duration, to adjust the sensitivity of the light sensing device 11 with respect to the high energy level visible light beam.

In the following description, a CMOS image sensor is taken for an example of the light sensing element 110. The light sensing element 110 can capture images according to the high energy level visible light beam, and output the captured images to the second controller 112. The second controller 112 determines the intensity of the high energy level visible light beam according to the received images. When the intensity of the high energy level visible light beam is larger than the threshold, the second controller 112 would output the second controller to the second wireless communication unit 111.

The second wireless communication unit 111 comprises proper logics, circuits and/or codes, and is configured to convert the identification signal provided by the second controller 112 into the wireless identification signal, and to output the wireless identification signal to the intelligent remote control 10. The second wireless communication unit 111 outputs the wireless identification signal also via the BlueTooth communication technology, the radio frequency identification communication technology, or Wi-Fi. Nevertheless, the second wireless communication unit 111 and the first wireless communication unit 101 need to use the same wireless communication technology for transmitting signals.

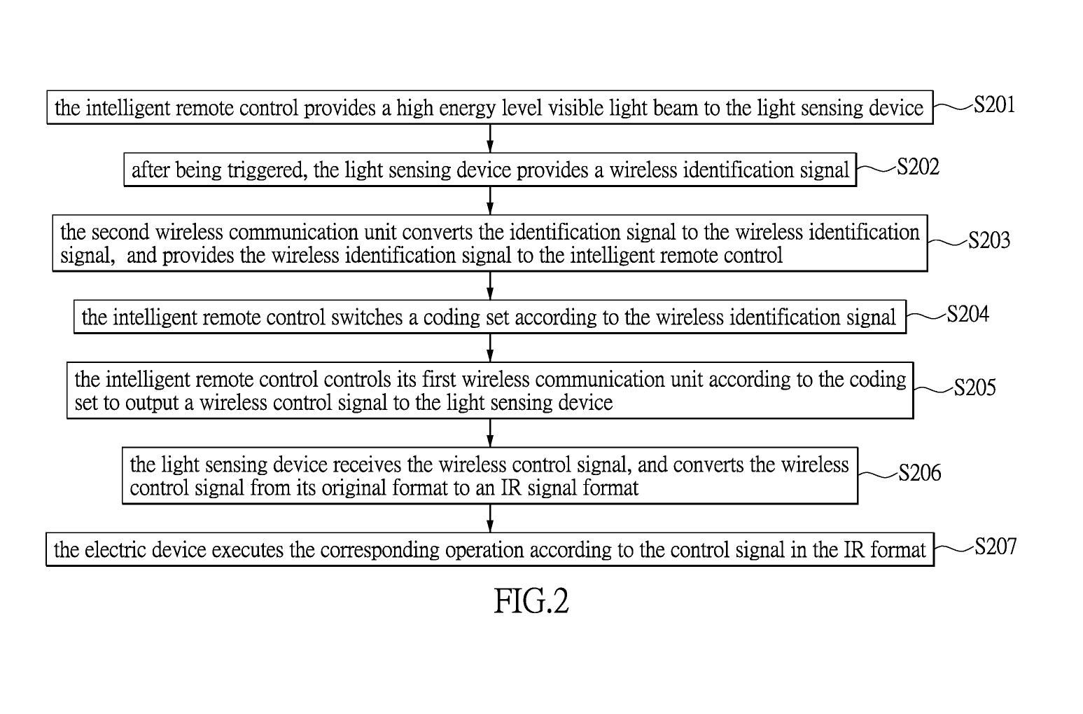

The following description is going to illustrate the operation flow of the electric device control system 1, and please refer to FIG. 2. FIG. 2 shows a flow chart of an electric device control method of one embodiment of the instant disclosure. In the Step S201, the intelligent remote control 10 provides the high energy level visible light beam lighting onto the light sensing device 11. As the electric device control system 1 comprises a plurality of electronic devices 12, the intelligent remote control 10 provides the high energy level visible light beam lighting onto the corresponding light sensing device 11 to control the electronic device 12 that it tends to control. In the Step S202, the light sensing element 110 of the light sensing device 11 generates the triggering signal according to the high energy level visible light beam. After being triggered, the second controller 112 of the light sensing device 11 receives the triggering signal and outputs the identification signal to the second wireless communication unit 111 according to the triggering signal. The identification signal comprises the device code and the coding type. In the Step S203, the second wireless communication unit 111 of the light sensing device 11 converts the identification signal into the wireless identification signal, and outputs the wireless identification signal to the intelligent remote control 10.

In the Step S204, the first wireless communication unit 101 of the intelligent remote control 10 receives the wireless identification signal, and then outputs the wireless identification signal to the first controller 102 of the intelligent remote control 10. The first controller 102 switches the coding set according to the coding type of the electronic device 12 labeled by the wireless identification signal. For example, coding types of the television and the air-conditioner are respectively the first coding type and the second coding type. As the intelligent remote control 10 receives the wireless identification signal provided by the light sensing device 11 corresponding to the television, the intelligent remote control 10 can tell which light sensing device 11 is transmitting the wireless identification signal according to the device code labeled by the wireless identification signal. After that, the first controller 102 switches the coding set according to the first coding type as labeled by the wireless identification signal, so as to control the television.

In the Step S205, the first controller 102 generates the control signal according to the coding set, and outputs the control signal to the first wireless communication unit 101 of the intelligent remote control 10. The first controller 102 controls the first wireless communication unit 101 to convert the control signal into the wireless control signal, and transmits the wireless control signal to the light sensing device 11.

In the Step S206, after the second wireless communication unit 111 of the light sensing device 11 receives the wireless control signal, the second wireless communication unit 111 outputs the wireless control signal to the second controller 112 for decoding. After that, the second controller 112 converts the decoded control signal from its original format to an IR signal format, and then outputs the converted control signal to the corresponding electronic device 12. In the Step S207, the electronic device 12 executes the corresponding operation according to this converted control signal.

According to the above, the intelligent remote control 10 provided by this embodiment provides an excellent operability, so that the user can choose the electronic device 12 to control directly via making the high energy level visible light beam provided by the intelligent remote control 10 light onto the light sensing device 11 of the chosen electronic device 12. In other words, as the intelligent remote control 10 makes the high energy level visible light beam light onto a light sensing device 11 of one electronic device 12, this electronic device 12 can be controlled. Thus, the intelligent remote control 10 provided by this embodiment can overcome the difficult operation of the interface of the traditional universal remote control.

On the other hand, the controlling range of the intelligent remote control 10 provided by this embodiment is larger, because the intelligent remote control 10 provided by this embodiment transmits the control signal not via the IR ray, but the wireless communication technology. Therefore, comparing with the traditional universal remote control, the intelligent remote control 10 provided by this embodiment has a larger controlling range. For example, the controlling range and the controlling angle of the traditional universal remote control may only be 7 meters and 60° (30° upward and 30° downward), but the controlling range of the intelligent remote control 10 provided by this embodiment is raised to 30 meters and the controlling angle of the intelligent remote control 10 provided by this embodiment is not limited.

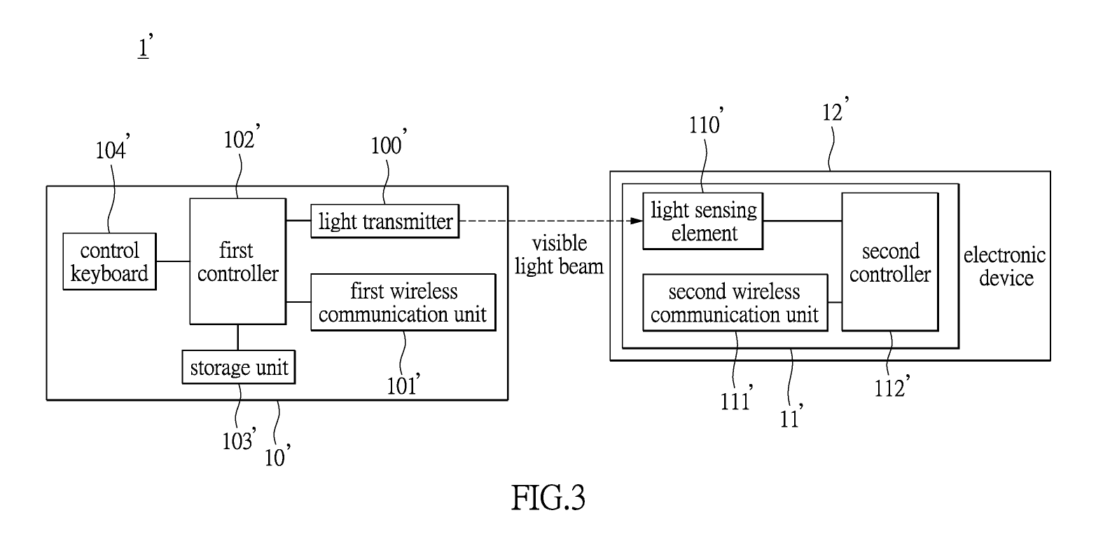

Please refer to FIG. 3, FIG. 3 shows a schematic diagram of an electric device control system of another embodiment of the instant disclosure. As the electric device control system 1 shown in FIG. 1, the electric device control system 1′ shown in FIG. 3 also comprises a intelligent remote control 10′, a light sensing device 11′ and an electronic device 12′. The deference between the electric device control system 1′ shown in FIG. 3 and the electric device control system 1′ shown in FIG. 3 is that, the above mentioned light sensing device 11 is an independent device electrically connected to the electronic device 12, but the light sensing device 11′ in this embodiment is configured inside the electronic device 12′.

The operation flow of the electric device control system 1′ shown in FIG. 3 is similar to the above mentioned electric device control system 1, and thus the redundant information is not repeated. By referring the description illustrating the FIG. 2, the skilled in the art should be able to understand the operation of the electric device control system 1′ shown in FIG. 3.

In this embodiment, the second controller 112′ can connect to the controller of the electronic device via the interior signal so as to output the decoded control signal or the converted control signal in the IR format to the controller of the corresponding electronic device, and the electronic device 12 executes the corresponding operation according to the received decoded or converted signal.

In other embodiments, the light sensing device 11 can also be an independent device that is connected outside or near the light sensing device. For example, the light sensing device 11 has an IR communication unit to transmit the converted control signal in the IR format to the electronic device 12, such that the electronic device 12 can operate according to that converted control signal in the IR format.

To sum up, the intelligent remote control, in the electric device control system and method provided by the instant disclosure, the electric device can be correspondingly controlled by directly providing a high energy level visible light beam to the light sensing device. Thereby, the user can control the position which the high energy level visible light beam lights onto, to make the high energy level visible light beam onto the light sensing device that the electronic device tends to control, so as to overcome the difficult operation of the interface of the traditional universal remote control. In other words, the universal remote control can make the user choose to control an electronic device directly and intuitively.

In addition, the intelligent remote control, the electric device control and method provided by the instant disclosure transmit the control signal via the wireless communication technology. Comparing with the traditional universal remote control, the intelligent remote control provided by the instant disclosure can provide a larger controlling range and the wider controlling angle.

Moreover, in the intelligent remote control, the electric device control and method provided by the instant disclosure, because of the one-to-one matching between the light sensing device and the electronic device, the electronic devices of the same brand or having the same model number can be respectively controlled, to overcome the fact that the traditional universal remote control is unable to recognize the electronic devices of the same brand or having the same model number.

The descriptions illustrated supra set forth simply the disclosed embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. An intelligent remote control, comprising:
a light transmitter, providing a high energy level visible light beam to a light sensing device, to make the light sensing device provide a wireless identification signal;
a first wireless communication unit, receiving the wireless identification signal; and
a first controller, electrically connected to the first wireless communication unit, controlling a coding set to switch according to the wireless identification signal, and controlling the first wireless communication unit according to the coding set to output a wireless control signal to the light sensing device for controlling an electric device.

2. The intelligent remote control according to claim 1, wherein the high energy level visible light beam is a laser beam.

3. The intelligent remote control according to claim 1, further comprising:
a storage unit, storing at least one coding set, and recording the wireless identification signal corresponding to each coding set, wherein the first controller switches the corresponding coding set according to the wireless identification signal provided by the storage unit, and each coding set records the wireless control signal corresponding to each button of the intelligent remote control.

4. The intelligent remote control according to claim 1, wherein the first wireless communication unit outputs the wireless control signal via at least one of BlueTooth communication technology, Radio Frequency Identification communication technology, or WI-FI.

5. An electric device control system, comprising:
at least one electric device, each electric device is electrically connected to a light sensing device, wherein the electric device is controlled by the light sensing device; and
an intelligent remote control, comprising:
a light transmitter, providing a high energy level visible light beam to a light sensing device, to make the light sensing device provide a wireless identification signal;
a first wireless communication unit, receiving the wireless identification signal; and
a first controller, electrically connected to the first wireless communication unit, controlling a coding set to switch according to the wireless identification signal, and controlling the first wireless communication unit according to the coding set to output a wireless control signal to the light sensing device for controlling the electric device.

6. The electric device control system according to claim 5, wherein the light sensing device comprises:
a light sensing element, receiving the high energy level visible light beam;
a second controller, electrically connected to the light sensing element, wherein the light sensing element generates a triggering signal when sensing the high energy level visible light beam, such that the second controller outputs an identification signal and the identification signal comprises a device code and a coding type;
a second wireless communication unit, electrically connected to the second controller, converting the identification signal to the wireless identification signal, and outputting the wireless identification signal to the intelligent remote control.

7. The electric device control system according to claim 6, wherein the light sensing device receives the wireless control signal via the second wireless communication unit, the second controller converts the wireless control signal from its original format to an IR signal format, and the light sensing device outputs the wireless control signal to the electric device such that the electric device executes the corresponding operation.

8. The electric device control system according to claim 7, wherein the light sensing device is an independent device and is electrically connected to the electric device, the light sensing device further comprises an IR communication unit to convert and transmit wireless control signal to the electric device.

9. The electric device control system according to claim 5, wherein the high energy level visible light beam is a laser beam.

10. The electric device control system according to claim 5, wherein the intelligent remote control further comprises:
a storage unit, storing at least one coding set, and recording the wireless identification signal corresponding to each coding set, wherein the first controller switches the corresponding coding set according to the wireless identification signal provided by the storage unit, and each coding set records the wireless control signal corresponding to each button of the intelligent remote control.

11. The electric device control system according to claim 5, wherein the first wireless communication unit outputs the wireless control signal via at least one of BlueTooth communication technology, Radio Frequency Identification communication technology, or WI-FI.

12. An electronic device control method, used in an electronic device control system, the electronic device control system comprising at least an electric device and an intelligent remote control, wherein each electric device is electrically connected to a light sensing device, the electronic device control method comprising:
(A) the intelligent remote control provides a high energy level visible light beam to the light sensing device;
(B) after being triggered, the light sensing device provides a wireless identification signal to the intelligent remote control;
(C) the intelligent remote control switches a coding set according to the wireless identification signal; and
(D) the intelligent remote control controls its first wireless communication unit according to the coding set to output a wireless control signal to the light sensing device for controlling the electric device.

13. The electronic device control method according to claim 12, wherein the step (B) further comprises:
(B-1) when a light sensing element of the light sensing device senses the high energy level visible light beam, the light sensing device outputs an identification signal, wherein the identification signal comprises a device code and a coding set; and
(B-2) the light sensing device converts the identification signal to the wireless identification signal, and outputs the wireless identification signal to the intelligent remote control.

14. The electronic device control method according to claim 12, further comprising:
(E) the light sensing device receives the wireless control signal, and converts the wireless control signal from its original format to an IR signal format; and
(F) the light sensing device outputs the converted wireless control signal to the electric device, such that the electric device executes the corresponding operation.

15. The electronic device control method according to claim 14,
wherein the light sensing device is an independent device and is electrically connected to the electric device, and
wherein in the step (F), the light sensing device further comprises an IR communication unit to convert and transmit wireless control signal to the electric device.

16. The electronic device control method according to claim 12, wherein the high energy level visible light beam is a laser beam.

17. The electronic device control method according to claim 12, wherein the first wireless communication unit outputs the wireless control signal via at least one of BlueTooth communication technology, Radio Frequency Identification communication technology, or WI-FI.
